(19) United States
(12) Patent Application Publication
(10) Pub. No.: US 2004/0078551 A1
(43) Pub. Date: Apr. 22, 2004

(54) Method for operating a data processing device as well as contruction of a data processing device as a memory-programmable control unit

(76) Inventor: Jochen Lichtenfels, Allendorf (DE)

Correspondence Address: Ira J. Schultz, DENNISON, SCHULTZ & DOUGHERTY, Suite 612, 1745 Jefferson Davis Highway, Arlington, VA, 22202, US

(21) Appl. No.: 10/326,261

(22) Filed: Dec. 23, 2002

(30) Foreign Application Priority Data
Dec. 21, 2001 (DE) 10163206.1-53

(51) Int. Cl. G06F 9/30

(52) U.S. Cl. 712/200

(57) ABSTRACT

The invention relates to a method for operating a data processing device (SPS) as a memory-programmable control unit. In order to attain a rapid processing of entry and/or outlet data with low memory consumption, the process includes the following steps:

Reading in entry data (E0 . . . En.n) applying on entry components (E0 . . . En),

Storing entry data in a memory (DS) as process image (PAE) of entries such that a bit allocated to each entry (E0.0 . . . En.n) of a memory position (SZ) is set to zero or one,

Building up a memory region according to the type of a stack (BIT, ST, BY ST, WST, DWST, QWST) with entry data (E0.0 . . . En.n) required with a subsequent program processing,

Loading the entry data (E0.0 . . . En.n) filed in the stack (BITST, BYST, BST, DWST, QWST) into the processor register,

Generating outlet data (A0.0 . . . An.n) by servicing a program code with the entry data deposited in the processor register (DX) such that the processor register (DX) contains corresponding outlet data following the processing,

Storage of the outlet data contained in the processor register (DX) into memory (DS) as a process image (PAA) of the outlets such that a bit of each memory position allocated to each outlet is set to zero or one, and

Transferring the outlet data (A0.0 . . . An.n) stored in memory to an outlet component (A0 . . . An).

A method for operating a data processing device as a memory-programmable control unit as well as construction of such is described, for example, in G. Strohrmann: Automation Engineering I, 4^{th} edition, R. Oldenbourg Verlag, 1998, p. 334 ff. According to this, the most important functional elements of a memory-programmable control unit are a control unit with one, sometimes also several microprocessors as well as a data memory with memory regions for times, counters, markers and process imagers and a program memory. Furthermore, input and output components as well as external time, count and limit valuators are provided. All components of the memory-programmable control unit are connected with one another through a bus or through busses over which data are transferred parallel or in series.

In accordance with a known mode of operation of a stored-programmable control unit, the control unit queries signal conditions at the entries of the input component of the control unit very rapidly one after the other at the beginning of each cycle and sets a storage position allocated to each entry in a process image to zero or one so that the memory locations of the data memory contain an image of the signal conditions of the entry after completion of this processing step. Usually the memory unit is organized by byte, that is each storage position has a data capacity of 8 bits (1 byte). The data capacity moreover makes clear how many binary units are accommodated in exactly one storage position.

Memory-programmable control units of the known type usually operate with fixed data types such as bytes (8 bits), words (16 bits), double words (D-words, 32 bits) or quadwords (Q-words, 64 bits). This means that all commands, data and addresses of these commands and data are stored with a position number which corresponds to the data type. The known memory units are constructed such that a cell with at least one number of bits, thus, for example, 8 bits, is filed under each memory address. One byte is thus the smallest addressable unit. In other words, with known memory-programmable control units, bit data which characterize the condition of an entry with zero or one are treated as bytes which has a great memory consumption as a consequence. Furthermore, the storage of information of an entry otherwise including 1 bit in a memory position is associated with the disadvantage that the entry data frequently must be unpacked and packed.

During a subsequent program processing, the microprocessor of the control unit returns to the process image stored in memory and processes the control instructions standing in the program memory independently of this. Moreover input/output data are transferred to the processor stack proper. A further disadvantage of known methods can be seen in the fact that needed parameters must be recopied during the nesting of functions/function blocks since memory units are firmly allocated for connections between functions/function blocks.

During program processing, the processor, for example, reads the signal condition of an entry E1.1 into its arithmetic unit and adds the signal condition of entry E2.1, for example. Thus a result can be filed in a register of the processor. After conclusion of program processing, thus at the end of the processing cycle, the control unit transfers the content of the register into the process image of the outlets and the content of the process image of the outlets to the output groups. After this, the control unit starts the next processing cycle by taking over the signal conditions of the entries, subsequent program processing and subsequent output of the process image of the outlets to the output groups.

Proceeding from this, the present invention is based on the problem of refining a method for operating a memory-programmable control unit as well as a memory-programmable control unit such that a rapid processing of entry and/or exit data is guaranteed with low memory consumption.

The problem is solved in accordance with the invention by the following operations:

Reading in entry data applying on entry components,

Storing entry data in a memory as process image of entries such that a bit allocated to each entry of a memory position is set to zero or one,

Building up a memory region according to the type of a stack with entry data required with a subsequent program processing,

Loading the entry data filed in the stack into the processor register,

Generating outlet data by servicing a program code with the entry data filed in the processor register such that the processor register contains corresponding outlet data following the processing,

Storage of the outlet data contained in the processor resister such that a bit of each memory position allocated to each outlet is set to zero or one, and

Transferring the outlet data stored in memory to an outlet component.

The method of the invention is based upon the thought of on the one hand depositing entry data as bit data in a memory as processor image of the entries or outlets and processing these data inside the processor in direct bit processing to attain a high processing speed. In this way, the advantage is attained that the memory-programmable control unit can operate with a low memory volume and that a frequent unpacking/packing of entry data filed as bytes can be dispensed with. The method has as a consequence that in addition to a small data area, even a very compact code can be used in programming the processor. A data processing device for implementing the method is characterized by the features of claim 13.

A preferred mode of operating is distinguished in that the entry data are built up as a bit stack and loaded into the processor register as DX data registers. In other words, the entry data are processed by bit in contrast to the method known from the state of the art, whereby a register of the processor is used as a stack. Moreover, the necessary data can be shifted by PUSH and POP functions.

A carry flag of the processor is used as a bit register in which results or interim results of a programming steps can be deposited. Inside the processor register, it is provided that an uppermost element of the stack (stack TOP) lies on the sign bit of the program register.

Beside processing entry data in a processor register as bit stack, processing entry data as word stack, byte stack, D-word stack as well as Q-word stack is also optional, whereby one or more processor registers are loaded during a cycle at a specified time with appropriate data from the built up stack. During stack processing, it is provided that the entry data or outlet data are deposited in a stack memory as described above, whereby when rolling in, a further element is inserted on the one lying uppermost in memory. This means that, when building up the stack, entry data lie according to the sequence of processing on the stack regardless of data format. After program processing, the results of processing can be removed from the stack which then represent the process image of the outlets of the output components.

It is provided that the stack is built up according to a certain algorithm or with a code generator to guarantee an optimal servicing of the programming codes so that the entries to be connected with one another in the cycle are filed in a suitable predefined servicing of the stack.

Bit stack processing is in particular distinguished in that a result of a linking of entry data is directly available on the bit stack, that is the processor register as well as data register, and is immediately available for further processing without using interim memories.

Internal conditions such as counters, timers, markers and different variables can be rolled in or rolled out through an independent reference memory. In other words, internal conditions are addressed through references. The reference memory can indicate all data types.

Furthermore, it has proven to be especially advantageous that only return addresses for the processing of nested functions/function blocks need be stored on the independent processor stack.

Further particulars, advantages and features of the invention emerge not only from the claims, the features which are to be gathered from these by themselves and/or in combination, but also from the following description of a preferred embodiment to be inferred from the drawings, wherein:

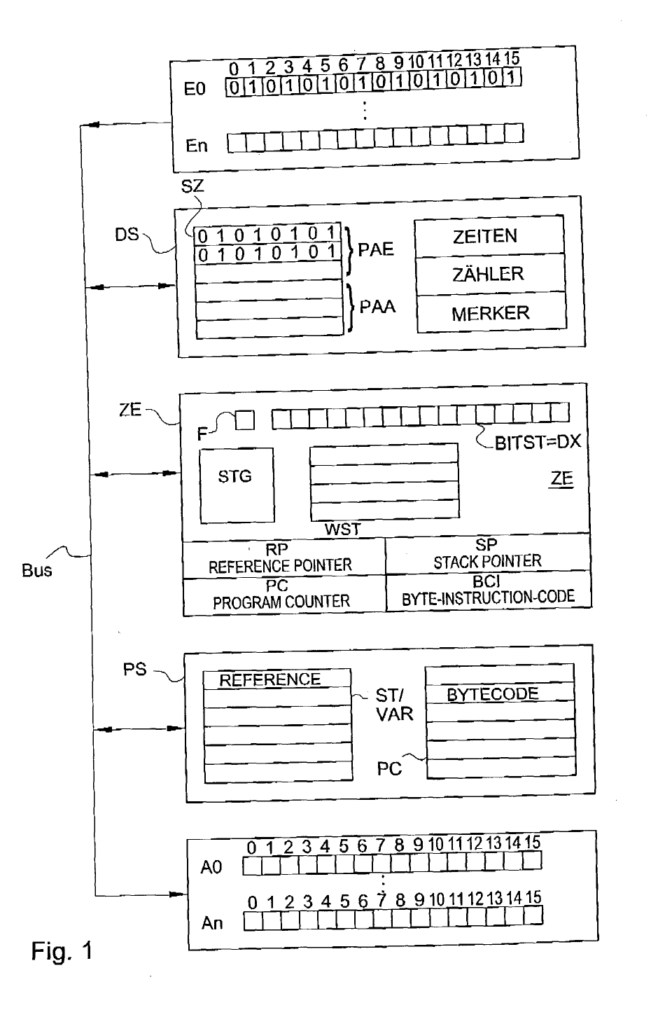

FIG. 1 A schematized construction of a memory-programmable control unit,

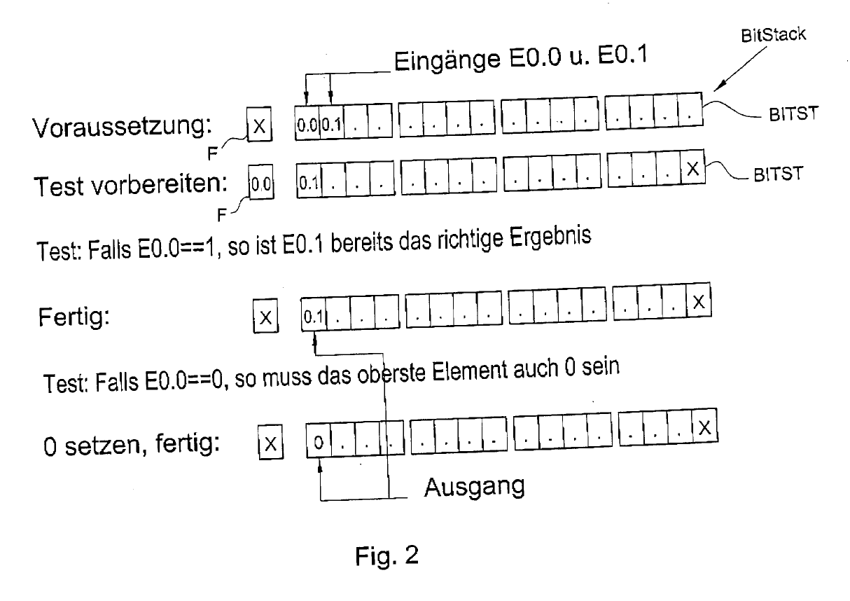

FIG. 2 A schematic representation of the servicing of a Boolean AND operation by means of a bit stack,

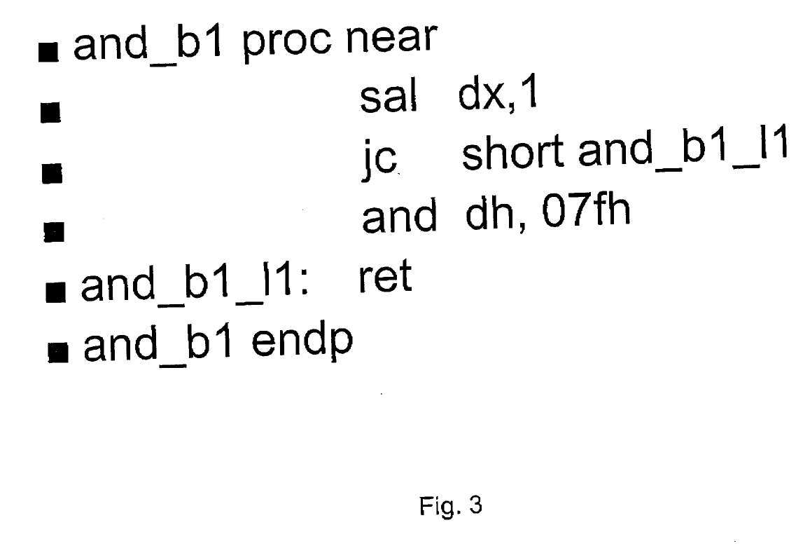

FIG. 3 An assembly program (X86) which represents the sequence of the Boolean AND operation according to FIG. 2 and

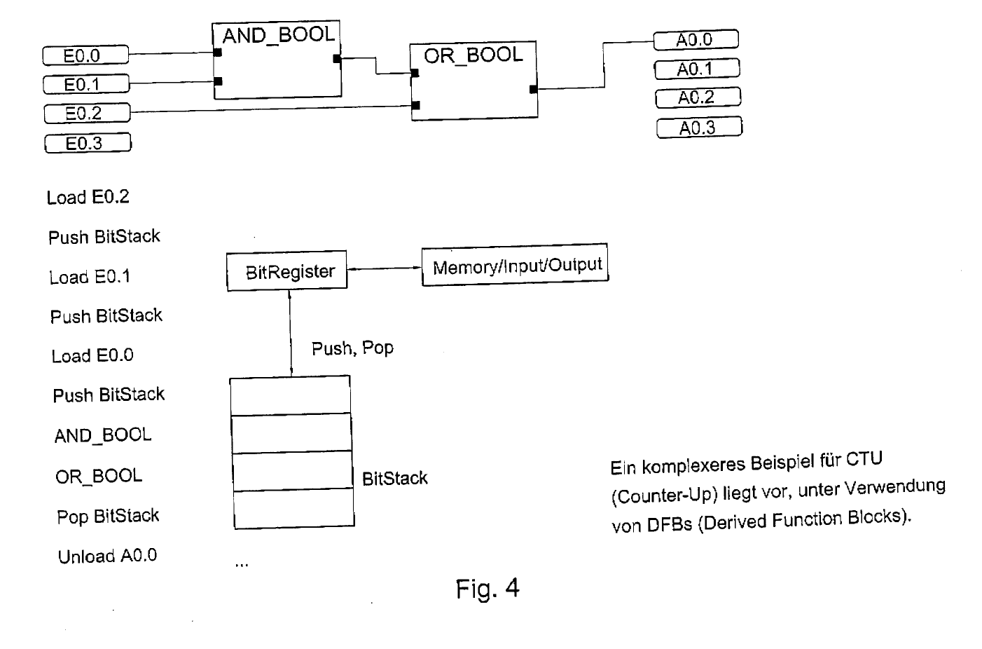

FIG. 4 A schematic representation of a Boolean AND/OR operation of three entry data.

FIG. 1 shows in a purely schematic manner the construction of a memory-programmable control unit SPS, including a central unit ZE which is connected through a bus BUS with a data memory DS, a program memory PS as well as one or more entry components E0 . . . En with entries E0.1 . . . En.n and outlet components A0 . . . An with outlets A0.0 . . . An.n. In the present embodiments, the entry component E0 has a data capacity of 16 bits including entries E0.0 to E0.15. At the beginning of the processing cycle, the entry data E0.0 . . . En.n lying on the entry components E0 . . . En are read in and deposited in data memory DS in an assigned memory region PAE as process image of the entries. In accordance with the invention, the data are stored such that a bit allocated to each entry E0.0 . . . En.n of a memory location SZ is set to zero or one. In other words, a signal of an entry E0.0 . . . En.n is allocated to each bit of a memory position.

In a further step, the entry data deposited in one or more memory locations SZ are if need be built up by processing a stack generator STG into one or more BST, WST, BST, DWST, QWST stacks. According to subsequent processing, the stacks can be built up as bit stack BIST, word stack WST, byte stack BST, D-word stack DWST as well as Q-word stack QWST.

In a preferred embodiment, that is with direct bit processing of the entry data, a processor register DX of the central unit ZE is loaded with the bit stacks BST content. For further processing, the entry data are taken from the bit stack and processed in accordance with a program code PC standing in the program memory PS by manipulation of the processor register DX such that the processor register DX, and therewith the bit stack BITST, appropriately contains outlet data A0.0 . . . An.n after processing. An example of a Boolean linkage of entries is explained with reference to FIG. 2.

The outlet data generated are subsequently placed on the stack ST (in the present example on the bit stack BITST) and are available for further processing, for example by nesting of functions/function blocks. This has the advantage that parameters, for example, need not be recopied during nesting of functions/function blocks. The outlet data A0.0 . . . An.n so generated are allocated to a memory region PAA as a process image of the outlets in data memory DS such that a bit of each memory position SZ allocated to each outlet is set to zero or one. Subsequently the outlet data stored in memory are transferred to the output components A0 . . . An and corresponding outlets A0.0 . . . An.n are set to zero or one.

Beside the bit-wise linking of individual outlets through logical or mathematical functions, the entry data can also be processed in data formats such as word, byte, D-word (double word) or Q-word (quad word), whereby corresponding stacks are generated by the stack generator. Consequently, for example, conditions or variables filed in the program memory PS can be addressed through references. The previously described mode of operation in particular offers the advantage in servicing nested functions/function blocks that interim results lie on the bit stack or word stack and are available immediately for a further processing without memories having to be firmly allocated for connection between functions/function blocks or parameters having to be recopied. In this way, the mode of operation of a conventional processor is simplified since only the return addresses to the function building blocks need be indicated on the processor stack INTST proper.

FIG. 2 shows purely schematically a direct bit processing of the invention using the bit stack with reference to the example of an AND BOOLEAN operation of processor series X86 (intel). The previously built up bit stack BITST is already loaded and contains the entry signals E0.0 as well as E2.4. The carry flag register which is used as a bit register is in an undefined state. By manipulating the bit stack, that is, for example, through a shift command, the entry value E0.0 is shifted into the flag F, which for example is comparable with the PUSH function of a stack (push bit stack=ROR DX,1). The value of the entry E0.0 is queried in the bit register F. In the event that E0.0 has the condition one, then the value of entry E2.4 lying on the stack top is already the correct result. In other words, the outlet data already lie on the bit stack. In the event that entry E0.0 has the value zero, then the uppermost element of the bit stack BITST would likewise have to be zero. The uppermost function is set to zero with a setting function. Even in this case, the outlet data are placed directly on the bit stack BITST and are available for further processing on the stack.

FIG. 3 shows an example of an assembly programming through which it becomes clear that a programming with a very compact code is possible. It should in particular be noted that nonetheless no data are used [with] codes in the extent of 8 bytes since the entries and outlets lie on the bit stack.

A further example for realizing a Boolean logic with AND and OR operation is represented in FIG. 4. First the bit stack is loaded with entry data E0.0, E0.1 and E0.2 in that PUSH operations are carried out on the bit stack. Then an AND operation of entries E0.0 and E0.1 can be carried out by manipulation of the bit stack as described with reference to FIG. 2. The result of the end linkage lying on the stack top is then OR-linked with entry E0.2 so that finally the result of outlet A0.0 lies on the stack top which is loaded out of the bit stack into memory for the process image of the outlets through a POP operation.

The function of the stack processor described with direct bit processing has advantages in comparison with the state of the art that a packing and unpacking of entry data filed as bytes is not necessary. From this, there results the advantage that the memory-programmable control unit manages with a very small data and consequently memory area. As a further advantage, it becomes apparent that the programming can be conducted with a very compact code, which simplifies programming the memory-programmable control unit overall and accelerates servicing. In addition to a good performance, which the memory-programmable control unit of the invention offers, only very small datasets are necessary, for example for animation. In particular, the memory-programmable control unit is suited for mini-SPS which for example includes 1 to 5 input/output components.

The structure of the SPS as well as the method of the invention has proven especially advantageous in coupling two memory-programmable control units, whereby one of the memory-programmable control units is operated merely in standby mode, especially hot standby mode. Through reducing the data volume, a direct shifting is possible by short-term recopying program data to the alternate control unit running in standby mode.

Furthermore, it should be mentioned that the method described and the processor structure described can be used independently of platform.

1. Method for operating a data processing device (SPS) as memory-programmable control unit including the following operations:
Reading in entry data (E0 . . . En.n) applying on entry components (E0 . . . En),
Storing entry data in a memory (DS) as process image (PAE) of entries such that a bit allocated to each entry (E0.0 . . . En.n) of a memory location (SZ) is set to zero or one,
Building up a memory region according to the type of a stack (BIT, ST, BY ST, WST, DWST, QWST) with entry data (E0.0 . . . En.n) required with a subsequent program processing,
Loading the entry data (E0.0 . . . En.n) filed in the stack (BITST, BYST, BST, DWST, QWST) into the processor register,
Generating outlet data (A0.0 . . . An.n) by servicing a program code with the entry data deposited in the processor register (DX) such that the processor register (DX) contains corresponding outlet data following the processing,
Storage of the outlet data contained in the processor register (DX) into memory (DS) as a process image (PAA) of the outlets such that a bit of each memory position allocated to each outlet is set to zero or one, and
Transferring the outlet data (A0.0 . . . An.n) stored in memory to an outlet component (A0 . . . An).

2. Method according to claim 1, characterized in that the entry data (E0.0 . . . En.n) are built up as a bit stack and are loaded into the processor register (DX) in the data register.

3. Method according to claim 1 or 2, characterized in that the entry data (E0.0 . . . En.n) and/or the outlet data (A0.0 . . . An.n) are processed bit-wise.

4. Method according to at least one of the preceding claims, characterized in that the processor register (DX) is used as a stack, whereby data required are shifted by PUSH/POP functions.

5. Method according to at least one of the preceding claims, characterized in that a flag register (F), preferably carry flag register of the processor, is used as a bit register for querying and linking of interim results of a program step.

6. Process according to at least one of the preceding claims, characterized in that an uppermost element (stack top) of the stack lies on the sig bit of the processor register (DX).

7. Method according to at least one of the preceding claims, characterized in that the build up of the stack takes place as a byte stack (BYST), word stack (WST), D-word stack (DWST) and Q-word stack (QWST), whereby during program processing one or more processor registers with corresponding bit, byte, word, D-word as well as Q-word data types are loaded.

8. Method according to at least one of the preceding claims, characterized in that the entry data and/or the outlet data are added to the element lying uppermost in memory while the stack is being built up during rolling in and the uppermost element is removed during rolling out.

9. Method according to at least one of the preceding claims, characterized in that, at the beginning of program processing, entry data lie on the stack, and in that the stack is occupied with outlet data once program processing has taken place.

10. Method according to at least one of the preceding claims, characterized in that the stack (BITST, BYST, WST) is built up according to a certain algorithm or with a code generator (CG).

11. Method according to at least one of the preceding claims, characterized in that internal conditions such as counter, timer and markers as well as variables on references are addressed.

12. Method according to a least one of the preceding claims, characterized in that merely return addresses for processing nested functions/function blocks are stored on the independent processor stack.

13. Data processing device (SPS) as a memory-programmable control unit, including:
One or more entry components (E0 . . . En) with applying entry data (E0 . . . En.),
A memory (DC) in which entry data are stored as a process image (PAE) of the entries such that a bit allocated to each entry (E0.0 . . . En.n) of a memory position (SZ) is set to zero or one,
A stack generator (STG) for building up a memory region according to the type of a stack (BIT, ST, BY ST, WST, DWST, QWST) with entry data (E0.0 . . . En.n) required with a subsequent program processing,
A processor register (DX) into which the entry data (E0.0 . . . En.n) filed in the stack (BITST, BYST, BST, DWST, QWST) are loaded, and in which outlet data (A0.0 . . . An.n) are generated by servicing a program code with the entry data (E0.0 . . . En.n) deposited in the processor register (DX) such that the processor register (DC) contains corresponding outlet data following processing,
A memory (DS) in which the outlet data contained in the processor register (DX) as a process image (PAA) of the outlets such that a bit of each memory position allocated to each outlet is set to zero or one, and
One or more output components (A0 . . . An) into which the stored outlet data (A0.0 . . . An.n) are transferred.
